(19) United States
(12) Patent Application Publication
(10) Pub. No.: US 2022/0109152 A1
(43) Pub. Date: Apr. 7, 2022

(54) ELECTRODE MATERIAL AND LITHIUM-ION ENERGY STORAGE DEVICE HAVING THE ELECTRODE MATERIAL

(71) Applicant: National Tsing Hua University, Hsinchu City (TW)

(72) Inventors: Shao-Chu Huang, Hsinchu City (TW); Chia-Ching Lin, Hsinchu City (TW); Tsung-Yi Chen, Hsinchu City (TW); Han-Yi Chen, Hsinchu City (TW)

(73) Assignee: National Tsing Hua University, Hsinchu City (TW)

(21) Appl. No.: 17/170,815

(22) Filed: Feb. 8, 2021

(30) Foreign Application Priority Data
Oct. 6, 2020 (TW) 109134519

(51) Int. Cl. H01M 4/525; H01M 10/0525; H01M 4/60; H01M 4/505; H01G 11/06; H01G 11/46; H01G 11/50; C07F 19/00

(52) U.S. Cl. CPC H01M 4/525; H01M 10/0525; H01M 4/60; C07F 19/005; H01G 11/06; H01G 11/46; H01G 11/50; H01M 4/505

(57) ABSTRACT

An electrode material and a lithium-ion energy storage device are provided. The electrode material includes at least one material selected from the following structures: a Keplerate-type polyoxometalate containing molybdenum and iron; a Keplerate-type polyoxometalate containing molybdenum and vanadium; a bi-capped Keggin-type polyoxometalate containing vanadium; and a polyoxometalate containing vanadium and a transition metal, wherein the transition metal is nickel, cobalt, iron, or manganese. A lithium-ion energy storage device having the above electrode materials may still maintain higher capacity at higher current density, and may still maintain the original capacity after many cycles.

### CROSS-REFERENCE TO RELATED APPLICATION

This application claims the priority benefit of Taiwan application serial no. 109134519, filed on Oct. 6, 2020. The entirety of the above-mentioned patent application is hereby incorporated by reference herein and made a part of this specification.

### BACKGROUND OF THE INVENTION

### Field of the Invention

The invention relates to a lithium ion-related composite energy storage technique, and particularly relates to an electrode material and a lithium-ion energy storage device having the electrode material.

### Description of Related Art

In recent years, mobile devices, electric vehicles, and renewable energies have been extensively developed and are expected to change human life. The demand for energy storage equipment is also increasing. At present, many researches are devoted to the development of electrochemical energy storage devices such as lithium-ion batteries, sodium-ion batteries, and supercapacitors, which may be used in, for example, portable electronic equipment and electric vehicles.

A battery has a high energy density and may store more electrical energy, but its low power density limits its charge and discharge speed. On the other hand, a supercapacitor has high power density and may be charged and discharged rapidly, but is limited by its low energy density. Therefore, the improvement of electrode materials is an important part of the research on electrochemical energy storage devices.

Negative electrode materials that perform better in the current academic journal literature, such as: silicon (Si) and tin oxide (SnO₂) although have good electrical properties, in order to avoid volume expansion leading to power decline, they often need to be modified or made into nano-scale particles, resulting in higher process costs.

### SUMMARY OF THE INVENTION

The invention provides an electrode material of a lithium-ion capacitor having a large molecular structure and does not collapse easily.

The invention also provides an electrode material of a lithium-ion battery. The molecule contains a large amount of transition metal to facilitate electron transfer.

The invention also provides a lithium-ion capacitor that may store high electrical energy and rapidly charge and discharge while achieving high energy density and high power density, and may still maintain the original capacity after many cycles.

The invention further provides a lithium-ion battery that may store high electrical energy and rapidly charge and discharge while achieving high energy density, high power density, and good stability.

An electrode material of the lithium-ion capacitor of the invention includes at least one material selected from the following structures: a Keplerate-type polyoxometalate containing molybdenum and iron; a Keplerate-type polyoxometalate containing molybdenum and vanadium; a bi-capped Keggin-type polyoxometalate containing vanadium; and a polyoxometalate containing vanadium and a transition metal, wherein the transition metal is nickel, cobalt, iron, or manganese.

An electrode material of a lithium-ion battery of the invention includes at least one material selected from the following structures: a Keplerate-type polyoxometalate containing molybdenum and iron; and a polyoxometalate containing vanadium and a transition metal, wherein the transition metal is nickel or manganese.

In an embodiment of the invention, the Keplerate-type polyoxometalate containing molybdenum and iron includes [{Mo₆O₁₉}⊂{Mo₇₂Fe₃₀O₂₅₄(CH₃COO)₁₂(H₂O)₉₆}].150H₂O (abbreviated as {Mo₇₂Fe₃₀}).

In an embodiment of the invention, the Keplerate-type polyoxometalate containing molybdenum and vanadium includes Na₂K₂₃{[(Mo^{VI})Mo^{VI}₅O₂₁(H₂O)₃(KSO₄)]₁₂[(V^{IV}O)₃₀(H₂O)₂₀(SO₄)_{0.5}]}.ca200H₂O (abbreviated as {Mo₇₂V₃₀}).

In an embodiment of the invention, the bi-capped Keggin-type polyoxometalate containing vanadium includes M1ₓM2_{y}PV₁₄O₄₂, M1 and M2 are cations, x+y=9, x>0, y≥0.

In an embodiment of the invention, the polyoxometalate containing vanadium and the transition metal includes M3ₐM4_{b}NiV₁₃O₃₈ or M3ₐM4_{b}MnV₁₃O₃₈, M3 and M4 are cations, a+b=9, a>0, b≥0.

In an embodiment of the invention, the electrode material may further include a conductive additive, a binding agent, or a combination thereof.

A lithium-ion capacitor of the invention includes a positive electrode, a negative electrode, and an electrolyte, wherein at least one of the positive electrode and the negative electrode contains the above electrode material of the lithium-ion capacitor, and the electrolyte is located between the positive electrode and the negative electrode.

A lithium-ion battery of the invention includes a positive electrode, a negative electrode, and an electrolyte, wherein at least one of the positive electrode and the negative electrode contains the above electrode material of the lithium-ion battery, and the electrolyte is located between the positive electrode and the negative electrode.

Based on the above, the electrode material of the invention has a large molecular structure and many transition metals (such as vanadium, molybdenum, iron, nickel, manganese, etc.) Therefore, the structure does not collapse and may transfer a lot of electrons. Therefore, the lithium-ion energy storage device having the electrode material may meet the needs of high current density and high capacity at the same time. In addition, after many cycles, since the volume of the particles does not expand and collapse, higher capacity may still be maintained.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of the structure of an electrode material of a lithium-ion capacitor according to the first embodiment of the invention.

FIG. 2 is a diagram of the structure of an electrode material of another lithium-ion capacitor according to the first embodiment of the invention.

FIG. 3 is a diagram of the structure of an electrode material of another lithium-ion capacitor according to the first embodiment of the invention.

FIG. 4 is a diagram of the structure of an electrode material of another lithium-ion capacitor according to the first embodiment of the invention.

FIG. 5 is a cross-sectional view of a lithium-ion energy storage device according to the third embodiment of the invention.

FIG. 6A is a constant current charge and discharge diagram of the lithium-ion half-cell of Experimental example 1 (electrode material {Mo₇₂Fe₃₀}) at a current density of 100 mA/g.

FIG. 6B is a graph of cyclic voltammetry of the lithium-ion half-cell of Experimental example 1 (electrode material {Mo₇₂Fe₃₀}) at different scan rates.

FIG. 6C is a constant current charge and discharge diagram of the lithium-ion half-cell of Experimental example 1 (electrode material {Mo₇₂Fe₃₀}) at different current densities.

FIG. 6D is a bar graph of the ratio between capacitance and intercalation of the lithium-ion half-cell of Experimental example 1 (electrode material {Mo₇₂Fe₃₀}) at different scan rates.

FIG. 7A is a constant current charge and discharge diagram of the lithium-ion half-cell of Experimental example 2 (electrode material {Mo₇₂V₃₀}) at a current density of 100 mA/g.

FIG. 7B is a graph of cyclic voltammetry of the lithium-ion half-cell of Experimental example 2 (electrode material {Mo₇₂V₃₀}) at different scan rates.

FIG. 7C is a constant current charge and discharge diagram of the lithium-ion half-cell of Experimental example 2 (electrode material {Mo₇₂V₃₀}) at different current densities.

FIG. 7D is a bar graph of the ratio between capacitance and intercalation of the lithium-ion half-cell of Experimental example 2 (electrode material {Mo₇₂V₃₀}) at different scan rates.

FIG. 8A is a graph of cycle performance and Coulomb efficiency of the lithium-ion half-cell of Experimental example 3 (electrode material PV₁₄) at a current density of 1000 mA/g.

FIG. 8B is a constant current charge and discharge diagram of the lithium-ion half-cell of Experimental example 3 (electrode material PV₁₄) at different current densities.

FIG. 8C is a graph of cycle performance of the lithium-ion capacitor of Experimental example 3 (electrode material PV₁₄) at different current densities.

FIG. 8D is a graph of cycle performance of the lithium-ion capacitor of Experimental example 3 (electrode material PV₁₄) at a large current density of 2 A/g.

FIG. 8E is a graph of power density and energy density of the lithium-ion capacitor of Experimental example 3 (electrode material PV₁₄).

FIG. 9A is a graph of cycle performance and Coulomb efficiency of the lithium-ion half-cell of Experimental example 4 (electrode material NiV₁₃) at current densities of 0.1 A/g and 5 A/g.

FIG. 9B is a constant current charge and discharge diagram of the lithium-ion half-cell of Experimental example 4 (electrode material NiV₁₃) at different current densities.

FIG. 9C is a graph of cycle performance of the lithium-ion capacitor of Experimental example 4 (electrode material NiV₁₃) at different current densities.

FIG. 9D is a graph of cycle performance of the lithium-ion capacitor of Experimental example 4 (electrode material NiV₁₃) at a large current density of 2 A/g.

FIG. 9E is a graph of power density and energy density of the lithium-ion capacitor of Experimental example 4 (electrode material NiV₁₃).

### DESCRIPTION OF THE EMBODIMENTS

The invention provides an electrode material of a lithium-ion energy storage device that provides the lithium-ion energy storage device with excellent performance in both power density and energy density, wherein even at a higher current density, higher capacity is still maintained, and after many cycles, the original capacity is still maintained.

In the following, embodiments are provided to describe actual implementations of the invention.

In the first embodiment, an electrode material of a lithium-ion capacitor includes at least one material selected from the following structures: a Keplerate-type polyoxometalate containing molybdenum and iron; a Keplerate-type polyoxometalate containing molybdenum and vanadium; a bi-capped Keggin-type polyoxometalate containing vanadium; and a polyoxometalate containing vanadium and a transition metal, wherein the transition metal is nickel, cobalt, iron, or manganese.

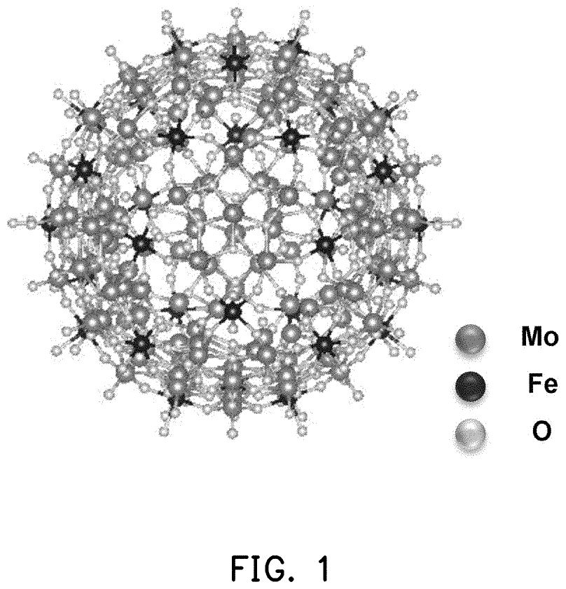

In the first embodiment, the Keplerate-type polyoxometalate containing molybdenum and iron is, for example, [{Mo₆O₁₉}⊂{Mo₇₂Fe₃₀O₂₅₄(CH₃COO)₁₂(H₂O)₉₆}].150H₂O (abbreviated as {Mo₇₂Fe₃₀}), and the structure diagram thereof is shown in FIG. 1. Although it is difficult to see the location of each element from FIG. 1, it may be obtained that the electrode material has a very large molecular structure. The Keplerate-type polyoxometalate containing molybdenum and iron may be synthesized by a solution method. A large amount of product may be obtained with only solution mixing. The synthesis method is simple and the output speed is extremely fast, and the particle size of the resulting {Mo₇₂Fe₃₀} is about several hundred nanometers, such as 100 nm to 200 nm. Since {Mo₇₂Fe₃₀} belongs to nano-grade particles and has high surface area, it facilitates desorption performance, making such electrode material preferable for lithium-ion capacitors (LICs). It may be found through experimental verification that when this polyoxometalate is made into an electrode material and placed at the negative electrode of a lithium-ion energy storage device, very high capacity performance may be achieved in the voltage range of 0.01 V to 3 V vs. Li/Li⁺, and higher capacity may still be maintained even at higher current density, and the original capacity may still be maintained after many cycles.

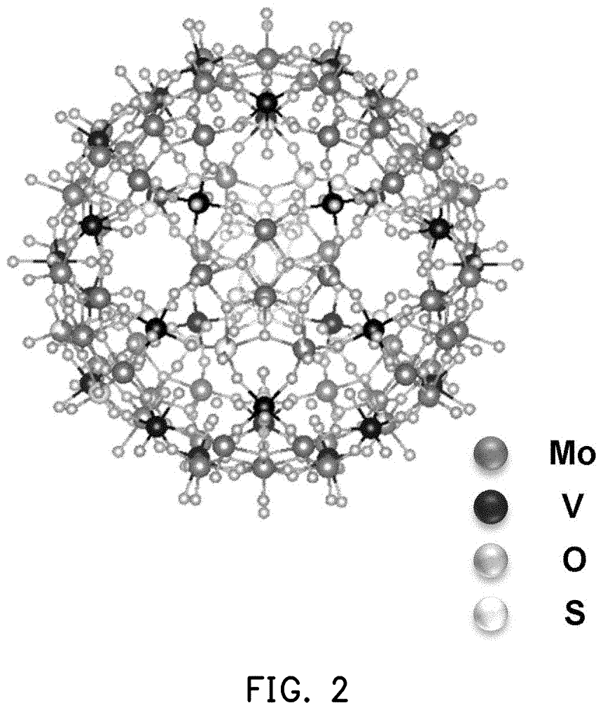

In the first embodiment, the Keplerate-type polyoxometalate containing molybdenum and vanadium is, for example, Na₂K₂₃{[(Mo^{VI})Mo^{VI}₅O₂₁(H₂O)₃(KSO₄)]₁₂[(V^{IV}O)₃₀(H₂O)₂₀(SO₄)_{0.5}]}.ca200H₂O (abbreviated as {Mo₇₂V₃₀}), and the structure diagram thereof is shown in FIG. 2. Although it is difficult to see the location of each element from FIG. 2, it may be obtained that the electrode material has a very large molecular structure. The Keplerate-type polyoxometalate containing molybdenum and vanadium is also synthesized by a solution method. The synthesis method is simple and the output speed is extremely fast. The particles of the resulting {Mo₇₂V₃₀} are also very small, about <10 μm. The Keplerate-type polyoxometalate containing molybdenum and vanadium also has very high capacity performance in the voltage range of 0.01 V to 3 V vs. Li/Li^{m}, and may still maintain higher capacity even at higher current density, and may still maintain the original capacity after many cycles.

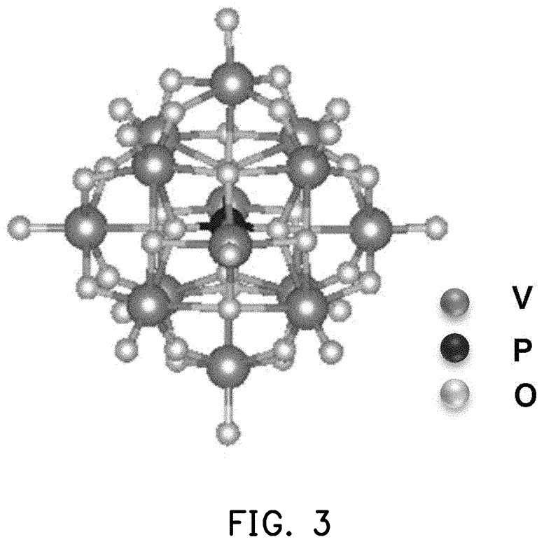

In the first embodiment, the bi-capped Keggin-type polyoxometalate containing vanadium includes M1ₓM2_{y}PV₁₄O₄₂ (abbreviated as PV₁₄), M1 and M2 are cations, x+y=9, x>0, y≥0. In an embodiment, M1 may be lithium, sodium, or potassium, M2 may be hydrogen, and M1 and M2 are different. For example, a bi-capped Keggin-type polyoxometalate containing vanadium, such as Na₇H₂PV₁₄O₄₂ has a structure shown in FIG. 3. The difference between bi-capped Keggin-type and general Keggin-type lies in the different elements in the structure. Keggin-type is mainly polyoxometalate based on Mo or W. The bi-capped Keggin-type polyoxometalate containing vanadium may be synthesized by a solution method, so the synthesis method thereof is simple and the output speed is extremely fast. The particle size of the resulting PV₁₄ is about 5 μm to 10 μm. The bi-capped Keplerate-type polyoxometalate containing vanadium also has very high capacity performance in the voltage range of 0.01 V to 3 V vs. Li/Li, and may still maintain high capacity even at high current density, and may still maintain the original capacity after many cycles.

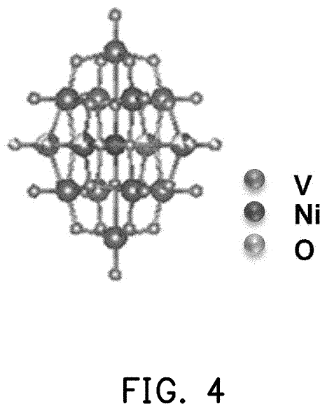

In the first embodiment, the polyoxometalate containing vanadium and the transition metal includes M3ₐM4_{b}NiV₁₃O₃₈ (abbreviated as NiV₁₃) or M3ₐM4_{b}MnV₁₃O₃₈ (abbreviated as MnV₁₃), M3 and M4 are cations, a+b=9, a>0, b≥0. In an embodiment, M3 may be lithium, sodium, or potassium, M4 may be hydrogen, and M3 and M4 are different. For example, the polyoxometalate containing vanadium and the transition metal, such as Na₇NiV₁₃O₃₈ or Na₇MnV₁₃O₃₈, has a structure shown in FIG. 4. The polyoxometalate containing vanadium and the transition metal may be synthesized by a solution method, so the synthesis method thereof is simple and the output speed is extremely fast. The particle size of the resulting NiV₁₃ and MnV₁₃ is about 5 μm to 10 μm. The polyoxometalate containing vanadium and the transition metal also has high capacity performance in the voltage range of 0.01 V to 3 V vs. Li/Li⁺, and may still maintain high capacity even at high current density, and may still maintain higher capacity after many cycles.

In the first embodiment, the electrode material may further include a conductive additive, a binding agent, or a combination thereof. The conductive additive is, for example, natural graphite, artificial graphite, carbon black, acetylene black, carbon fiber, metal powder, metal fiber, or conductive ceramic material. The binding agent may adopt a currently existing binding agent.

In the second embodiment, an electrode material of the lithium-ion battery of the invention includes at least one material selected from the following structures: a Keplerate-type polyoxometalate containing molybdenum and iron; and a polyoxometalate containing vanadium and a transition metal, wherein the transition metal is nickel, cobalt, iron, or manganese. The Keplerate-type polyoxometalate containing molybdenum and iron and the polyoxometalate containing vanadium and the transition metal of the second embodiment are as described in the first embodiment (as shown in FIG. 1 and FIG. 4) and are therefore not repeated herein. Moreover, the Keplerate-type polyoxometalate containing molybdenum and iron and the polyoxometalate containing vanadium and the transition metal have a large amount of transition metal to transfer electrons, and therefore facilitate the intercalation/deintercalation of lithium ions, and are suitable for electrode materials of lithium-ion batteries.

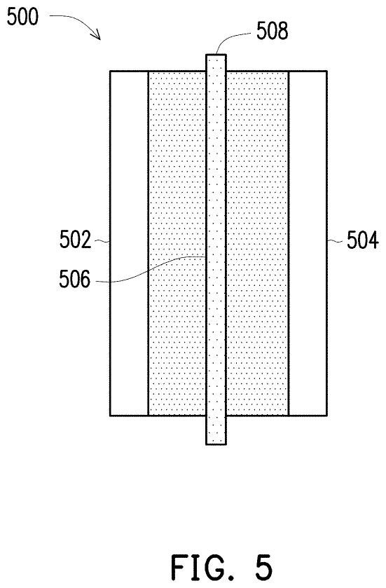

FIG. 5 is a cross-sectional view of a lithium-ion energy storage device according to the third embodiment of the invention. Referring to FIG. 5, a lithium-ion energy storage device 500 includes at least a positive electrode 502, a negative electrode 504, and an electrolyte 506, wherein the electrolyte 506 is located between the positive electrode 502 and the negative electrode 504, and the electrolyte 506 may be liquid, colloidal, molten salt, or solid electrolyte. At least one of the positive electrode 502 and the negative electrode 504 includes the electrode material in the above embodiments, and may be made by mixing the electrode material, a conductive additive, and a binding agent into a slurry and coating the slurry on a metal plate (not shown). However, the invention is not limited thereto. In an embodiment, if the lithium-ion energy storage device 500 is a lithium-ion capacitor, then at least one of the positive electrode 502 and the negative electrode 504 contains the above Keplerate-type polyoxometalate containing molybdenum and iron, the above Keplerate-type polyoxometalate containing molybdenum and vanadium, the above bi-capped Keggin-type polyoxometalate containing vanadium, the above polyoxometalate containing vanadium and the transition metal, or a combination of the above materials. In another embodiment, if the lithium-ion energy storage device 500 is a lithium-ion battery, then at least one of the positive electrode 502 and the negative electrode 504 contains the Keplerate-type polyoxometalate containing molybdenum and iron, the polyoxometalate containing vanadium and the transition metal, or a combination of the above materials.

In the third embodiment, the lithium-ion energy storage device 500 may further include a separator 508 disposed between the positive electrode 502 and the negative electrode 504, wherein the material of the separator 508 is an insulating material such as polyethylene (PE), polypropylene (PP), or a composite structure formed by the above materials (such as PE/PP/PE or Celgard® 2500).

Experiments are described below to verify the efficacy of the disclosure. However, the disclosure is not limited to the following content.

### <Preparation Example 1> Preparation of {Mo₇₂Fe₃₀}

7.7 mmol of FeCl₃.6H₂O was added to a solution containing 12.3 mmol of Na₂MoO₄.2H₂O and 25 ml of H₂O to be mixed and stirred, and then 15 ml of 100% CH₃COOH was added to adjust the pH. The mixture was left to stand for 30 minutes to wait for the material to precipitate, then the material was washed and dried to obtain the product [{Mo₆O₁₉}⊂{Mo₇₂Fe₃₀O₂₅₄(CH₃COO)₁₂ (H₂O)₉₆}].150H₂O, with a yield ≈2 g and a particle size of about 100 nm to 200 nm. This preparation method may quickly precipitate the above product without heating or cooling and without the use of chemicals such as ethanol.

### <Preparation Example 2> Preparation of {Mo₇₂V₃₀}

10 mmol of VOSO₄.5H2O dissolved in 35 ml of water was added to 8 ml of 0.5 M H₂SO₄ solution containing 10 mmol of Na₂MoO₄.2H₂O and mixed and stirred for 30 minutes, then 8.72 mmol of KCl was added and stirred for 30 minutes. After the material was precipitated, the material was filtered and washed with 4° C. deionized water, and then dried to obtain the product Na₂K₂₃{[(Mo^{VI})Mo^{VI}₅O₂₁ (H₂O)₃(KSO₄)]₁₂[(V^{IV}O)₃₀(H₂O)₂₀(SO₄)_{0.5}]}.ca200H₂O with a yield of 1.84 g (32.7%) and a particle size of about 2 μm to 3 μm.

### <Preparation Example 3> Preparation of PV₁₄

First, 2.25 g of NaVO₃ was dissolved in 12.5 ml of hot water at 100° C., then after filtering and cooling to room temperature, 3.1 ml of 1.5 M H₃PO₄ was added while stirring, then 3 M HNO₃ was poured in to lower the pH from 6.0 to 2.3. The solution was kept in a steam bath at 50° C. and a hot concentrated NaCl solution (5 g in 20 ml water) was slowly added. After cooling to room temperature, brown powder was obtained by adding ethanol (solution with same volume), and then the precipitate was filtered and air-dried to obtain the product Na₇H₂PV₁₄O₄₂ with a yield=1 g and a particle size of about 5 μm to 10 μm.

### <Preparation Example 4> Preparation of NiV₁₃

First, 31.7 g of NaVO₃ was dissolved in 700 ml of deionized water at 80° C. and stirred, and 20 ml of 1M HNO₃ and 20 ml of 1M NiSO₄ were added to adjust the pH, then the mixture was stirred for 4 hours to wait for the material to precipitate, then the material was filtered at room temperature and crystallized at low temperature at 4° C. After drying, the product Na₇NiV₁₃O₃₈ was obtained, with a yield=15 g and a particle size of about 5 μm to 10 μm.

### Experimental Example 1

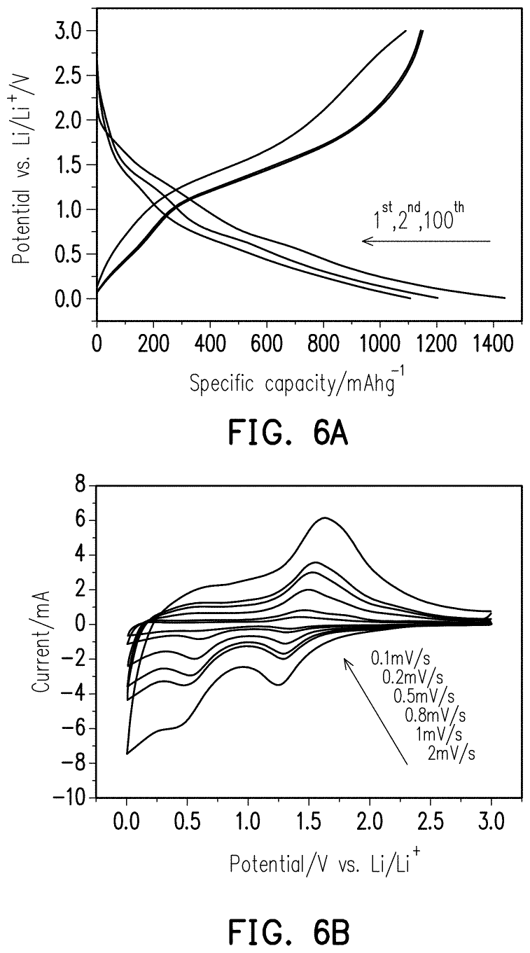

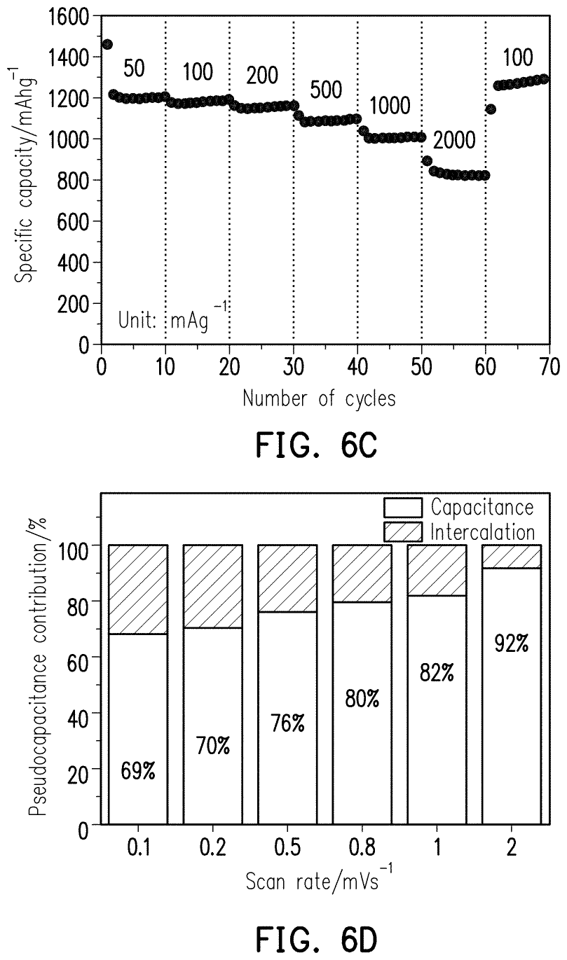

The product {Mo₇₂Fe₃₀} of Preparation example 1 together with the conductive additive Super P® and a binding agent were formulated into a mixture in a weight ratio of 70:20:10. After grinding, the mixture was added into deionized water containing 5 wt % CMC+SBR, then the mixture was stirred evenly and then coated on a copper sheet, and then dried to obtain an electrode sheet. This electrode sheet was made into a half-cell, and 1M LiPF₆ in ethylene carbonate (EC) and diethyl carbonate (DEC) (volume ratio 1:1) was used as an electrolyte for electrochemical specific detection. The results are shown in FIG. 6A to FIG. 6D.

FIG. 6A is a constant current charge and discharge diagram at a current density of 100 mA/g; FIG. 6B is a graph of cyclic voltammetry at different scan rates; FIG. 6C is a constant current charge and discharge diagram at different current densities; and FIG. 6D is a bar graph of the ratio between capacitance and intercalation at different scan rates. From FIG. 6A, it may be seen that a relatively stable slope is obtained in the voltage range of 0.01 V to 3 V vs. Li/Li⁺; and it may be seen from FIG. 6B that the main reaction potential of {Mo₇₂Fe₃₀} is always 1 V or less, and therefore {Mo₇₂Fe₃₀} is suitable as a negative electrode material, and there is no significant polarization phenomenon even at high scan rate, thus enabling rapid redox reaction. It may be seen from FIG. 6C that high capacity may be achieved at high current density. From FIG. 6D, it may be seen that (absorption and desorption) capacitance is the sole contributor to the very fast rate, so {Mo₇₂Fe₃₀} may be used not only for lithium-ion batteries, but is also suitable for lithium-ion capacitors.

### Experimental Example 2

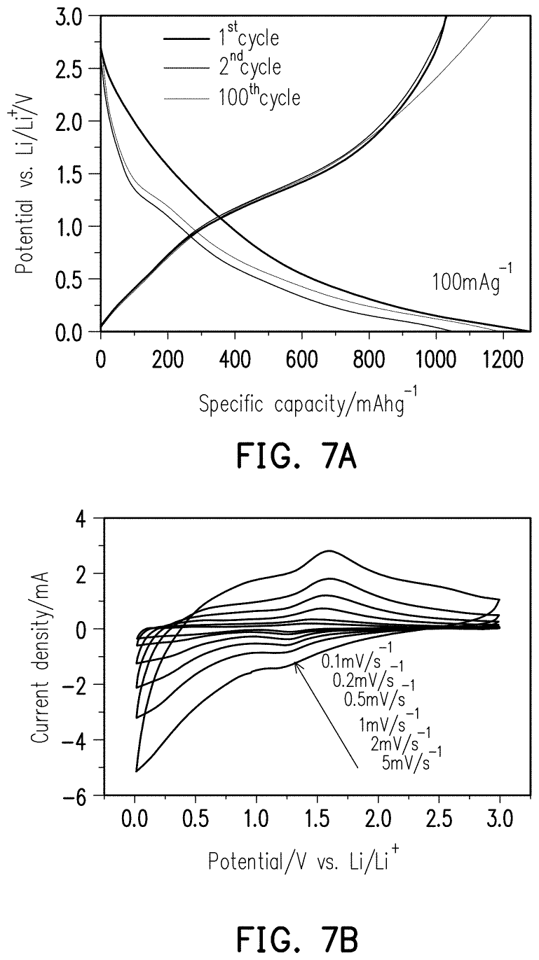

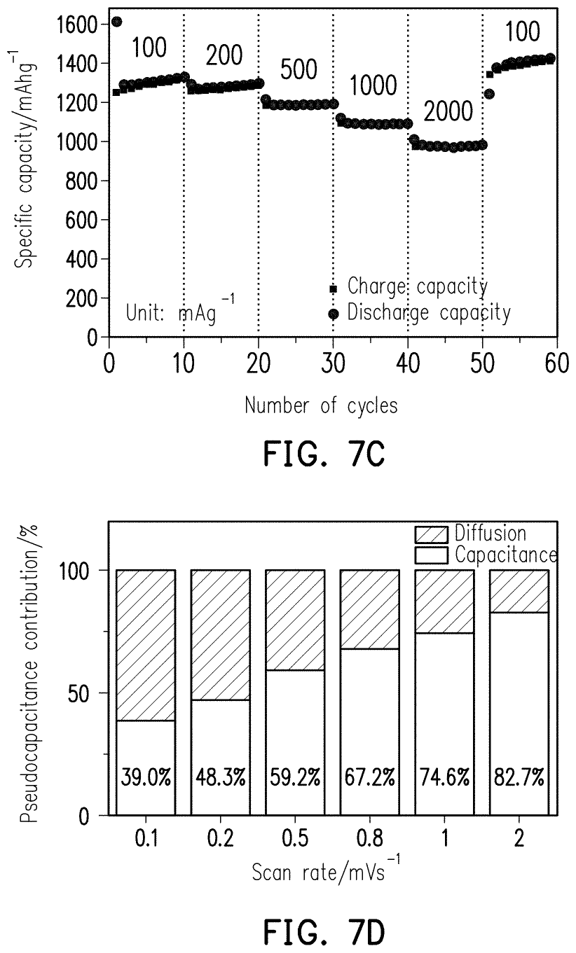

A half-cell was fabricated as in Experimental example 1, but the product of Preparation example 1 was replaced by the product {Mo₇₂V₃₀} of Preparation example 2. Then the electrochemical specific detection was also performed, and the results are shown in FIG. 7A to FIG. 7D.

FIG. 7A is a constant current charge and discharge diagram at a current density of 100 mA/g; FIG. 7B is a graph of cyclic voltammetry at different scan rates; FIG. 7C is a constant current charge and discharge diagram at different current densities; and FIG. 7D is a bar graph of the ratio between capacitance and intercalation at different scan rates. From FIG. 7A, it may also be seen that a relatively stable slope is obtained in the voltage range of 0.01 V to 3 V vs. Li/Li⁺; and it may be seen from FIG. 7B that the main reaction potential of {Mo₇₂V₃₀} is always 1 V or less, and therefore {Mo₇₂V₃₀} is suitable as a negative electrode material, and there is no significant polarization phenomenon even at high scan rate, thus enabling rapid redox reaction.

From FIG. 7C, high capacities 1200 mA h g⁻¹, 1175 mA h g⁻¹, 1150 mA h g⁻¹, 1100 mA h g⁻¹ 1000 mA h g⁻¹, and 850 mA h g⁻¹ are observed at different current densities (50 mA/g, 100 mA/g, 200 mA/g, 500 mA/g, 1000 mA/g, and 2000 mA/g) respectively. Therefore, even at higher current density, high capacity may still be maintained. It may be seen from FIG. 7D that (absorption and desorption) capacitance contributes the most to the faster rate, so {Mo₇₂V₃₀} is suitable for lithium-ion capacitors.

### Experimental Example 3

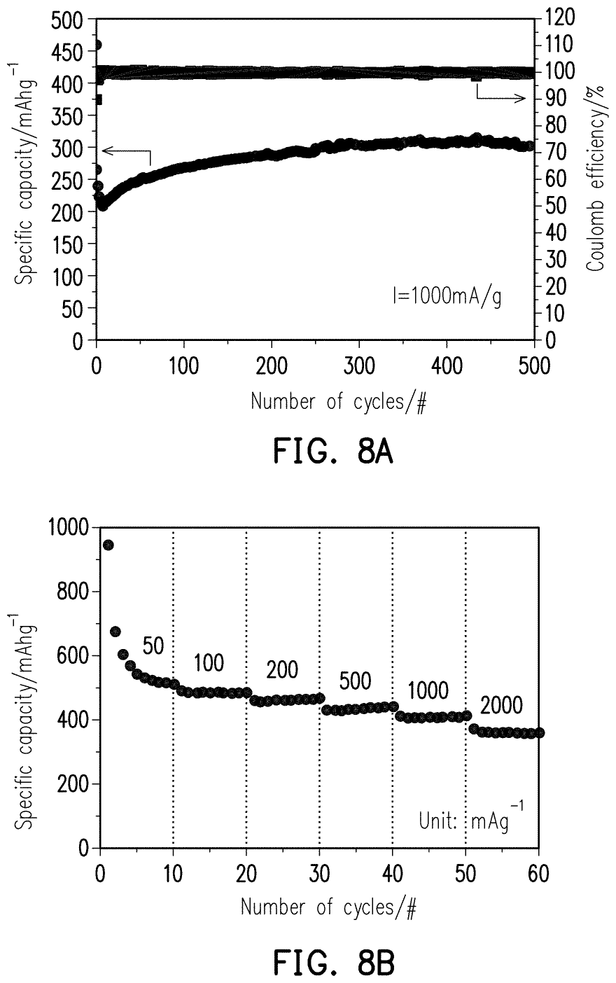

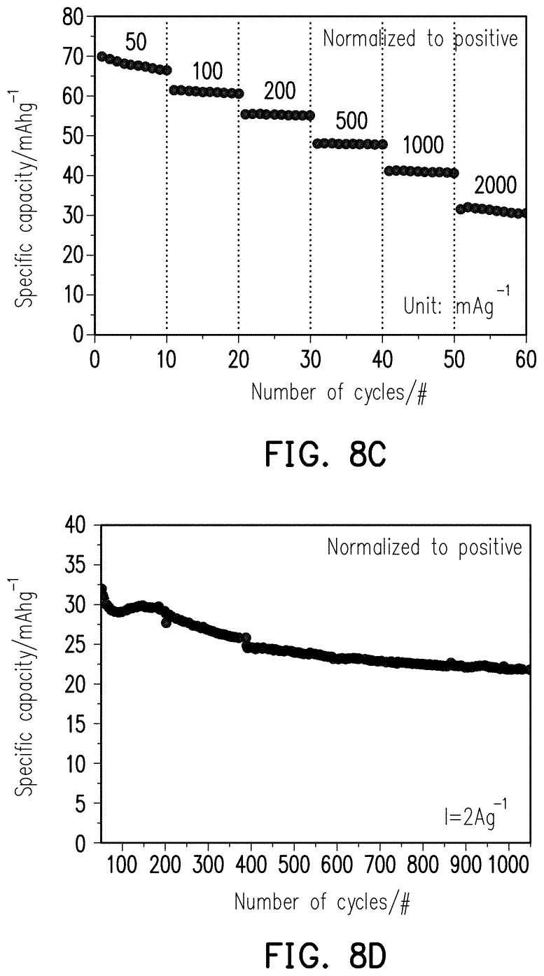

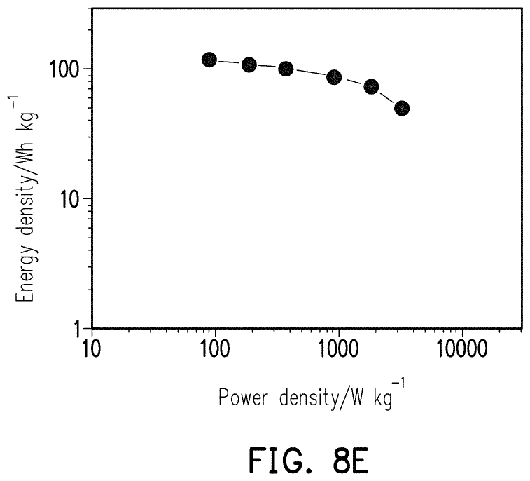

A half-cell was fabricated as in Experimental example 1, but the product of Preparation example 1 was replaced by the product PV₁₄ of Preparation example 3. Then, the cycle performance and the Coulomb efficiency of the lithium-ion half-cell at a current density of 1000 mA/g were measured to obtain FIG. 8A. It may be seen from FIG. 8A that the capacity remained at about 300 mA h g⁻¹ without decline even after 500 cycles at a current density of 1000 mA/g.

Then, the constant current charge and discharge of the lithium-ion half-cell at different current densities were measured to obtain FIG. 8B. From FIG. 8B, the capacities 550 mA h g⁻¹, 465 mA h g⁻¹, 440 mA h g⁻¹, 410 mA h g⁻¹ and 365 mA h g⁻¹ are observed at different current densities (50 mA/g, 100 mA/g, 200 mA/g, 500 mA/g, 1000 mA/g, and 2000 mA/g) respectively. Therefore, even at higher current density, high capacity may still be maintained.

In addition, the electrode sheet (electrode material PV₁₄) made according to the method of Experimental example 1, a separator (Celgard® 2500), and an active carbon positive electrode sheet were formed into a lithium-ion capacitor, and 1M LiPF₆ in EC and DEC (volume ratio 1:1) was used as the electrolyte for electrochemical specific detection. The results are shown in FIG. 8C and FIG. 8D.

It may be seen from FIG. 8C that the capacity may be maintained above a predetermined value at different current densities. From FIG. 8D, it may be seen that the lithium-ion capacitor of Experimental example 3 has good cycle performance at a large current density of 2 A/g.

The electrochemical performance of PV₁₄ with commercial activated carbon (YP80F) for the positive electrode is shown in FIG. 8E. At a power density of 89 W kg¹ to 3230 W kg⁻¹, the energy density is 121 W h kg⁻¹ to 51 W h kg⁻¹. Therefore, the lithium-ion capacitor of Experimental example 3 (electrode material PV₁₄) may take into account the performance of both power density and energy density.

### Experimental Example 4

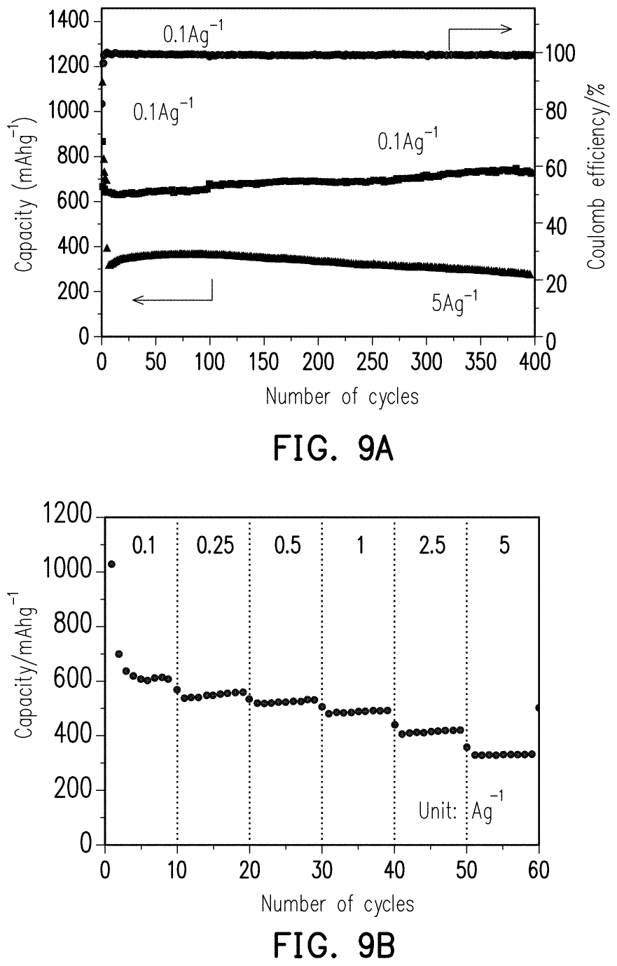

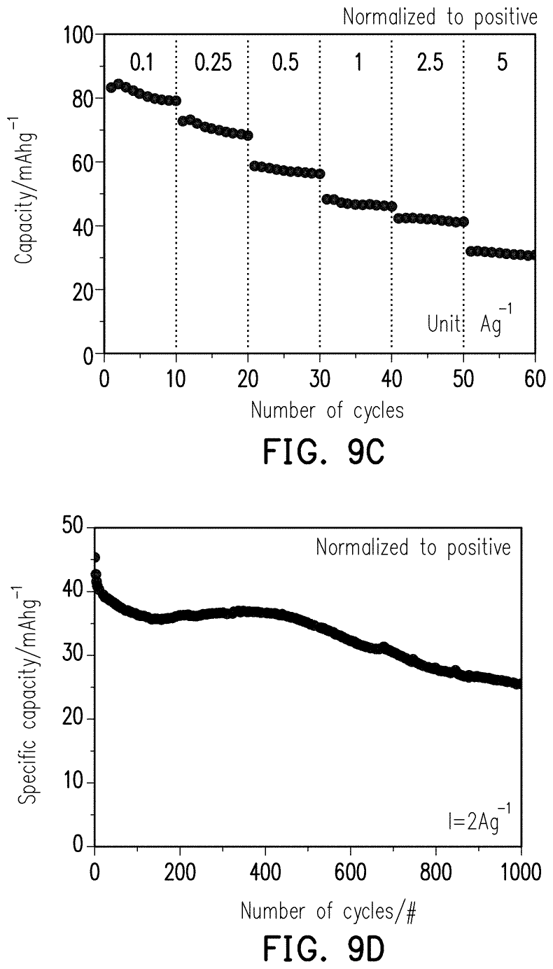

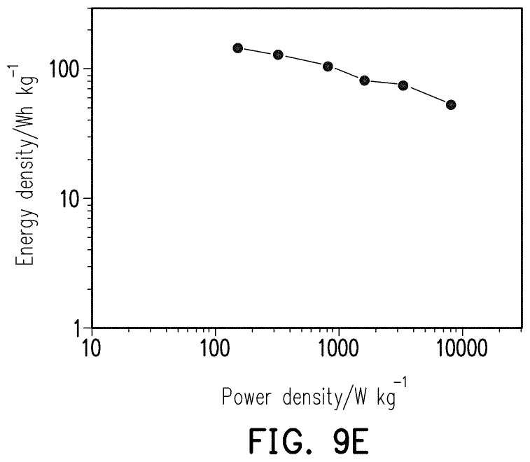

A half-cell was fabricated as in Experimental example 1, but the product of Preparation example 1 was replaced by the product NiV₁₃ of Preparation example 4. Then, the cycle performance and the Coulomb efficiency of the lithium-ion half-cell at current densities of 0.1 A/g and 5 A/g were measured to obtain FIG. 9A. Then, the constant current charge and discharge of the lithium-ion half-cell at different current densities were measured to obtain FIG. 9B.

It may be obtained from FIG. 9A and FIG. 9B that electrode materials including NiV₁₃ lithium-ion half-cells have high capacity (capacity of 700 mA h g⁻¹ at current density of 0.1 A/g), fast charge and discharge (capacities of 482 mA h g⁻¹ and 331 mA h g⁻¹ at high charge rates of 1 A/g and 5 A/g, respectively), and long cycle stability.

In addition, the electrode sheet (electrode material NiV₁₃ made according to the method of Experimental example 1, a separator (Celgard® 2500), and an active carbon positive electrode sheet were formed into a lithium-ion capacitor, and 1M LiPF₆ in EC and DEC (volume ratio 1:1) was used as the electrolyte for electrochemical specific detection. The results are shown in FIG. 9C and FIG. 9D.

It may be seen from FIG. 9C that the capacity may be maintained above a predetermined value at different current densities. From FIG. 9D, it may be seen that the lithium-ion capacitor of Experimental example 4 has good cycle performance at a large current density of 2 A/g.

The electrochemical performance of NiV₁₃ with commercial activated carbon (YP80F) for the positive electrode is shown in FIG. 9E. At a power density of 169 W kg⁻¹ to 8821 W kg⁻¹, the energy density is 140 W h kg⁻¹ to 52 W h kg⁻¹, and the electrochemical performance thereof is better than Experimental example 3. Therefore, the lithium-ion capacitor of Experimental example 4 (electrode material NiV₁₃) may also take into account the performance of both power density and energy density.

Based on the above, the electrode material of the invention has a larger molecular structure and a large amount of transition metal. Therefore, even after many cycles, the structure still does not collapse and may transfer a lot of electrons. Therefore, the lithium-ion energy storage device having the electrode material may meet the needs of high current density and high capacity at the same time. In addition, after many cycles, the volume does not expand and collapse, and may still maintain higher capacity.

Although the invention has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. An electrode material of a lithium-ion capacitor, comprising at least one material selected from the following structures:
a Keplerate-type polyoxometalate containing molybdenum and iron;
a Keplerate-type polyoxometalate containing molybdenum and vanadium;
a bi-capped Keggin-type polyoxometalate containing vanadium; and
a polyoxometalate containing vanadium and a transition metal, wherein the transition metal is nickel, cobalt, iron, or manganese.

2. The electrode material of the lithium-ion capacitor of claim 1, wherein the Keplerate-type polyoxometalate containing molybdenum and iron comprises [{Mo₆O₁₉}⊂{Mo₇₂Fe₃₀O₂₅₄(CH₃COO)₁₂(H₂O)₉₆}].150H₂O (abbreviated as {Mo₇₂Fe₃₀}).

3. The electrode material of the lithium-ion capacitor of claim 1, wherein the Keplerate-type polyoxometalate containing molybdenum and vanadium comprises Na₂K₂₃{[(Mo^{VI})Mo^{VI}₅O₂₁(H₂O)₃(KSO₄)]₁₂[(V^{IV}O)₃₀(H₂O)₂₀(SO₄)_{0.5}]}.ca200H₂O (abbreviated as {Mo₇₂V₃₀}).

4. The electrode material of the lithium-ion capacitor of claim 1, wherein the bi-capped Keggin-type polyoxometalate containing vanadium comprises M1ₓM2_{y}PV₁₄O₄₂, M1 and M2 are cations, x+y=9, x>0, y≥0.

5. The electrode material of the lithium-ion capacitor of claim 1, wherein the polyoxometalate containing vanadium and the transition metal comprises M3ₐM4_{b}NiV₁₃O₃₈ or M3ₐM4_{b}MnV₁₃O₃₈, M3 and M4 are cations, a+b=9, a>0, b≥0.

6. The electrode material of the lithium-ion capacitor of claim 1, further comprising a conductive additive, a binding agent, or a combination thereof.

7. A lithium-ion capacitor, comprising: a positive electrode; a negative electrode; and an electrolyte located between the positive electrode and the negative electrode, wherein at least one of the positive electrode and the negative electrode contains the electrode material of claim 1.

8. An electrode material of a lithium-ion battery, comprising at least one material selected from the following structures:
a Keplerate-type polyoxometalate containing molybdenum and iron; and
a polyoxometalate containing vanadium and a transition metal, wherein the transition metal is nickel or manganese.

9. The electrode material of the lithium-ion battery of claim 8, wherein the Keplerate-type polyoxometalate containing molybdenum and iron comprises [{Mo₆O₁₉}⊂{Mo₇₂Fe₃₀O₂₅₄(CH₃COO)₁₂(H₂O)₉₆}].150H₂O (abbreviated as {Mo₇₂Fe₃₀}).

10. The electrode material of the lithium-ion battery of claim 8, wherein the polyoxometalate containing vanadium and the transition metal comprises M3ₐM4_{b}NiV₁₃O₃₈ or M3ₐM4_{b}MnV₁₃O₃₈, M3 and M4 are cations, a+b=9, a>0, b≥0.

11. The electrode material of the lithium-ion battery of claim 8, further comprising a conductive additive, a binding agent, or a combination thereof.

12. A lithium-ion battery, comprising: a positive electrode; a negative electrode; and an electrolyte located between the positive electrode and the negative electrode, wherein at least one of the positive electrode and the negative electrode contains the electrode material of claim 8.
